(19) United States
(12) Patent Application Publication
(10) Pub. No.: US 2007/0106012 A1
(43) Pub. Date: May 10, 2007

(54) Modified carbon particles

(76) Inventors: Krzysztof Matyjaszewski, Pittsburgh, PA (US); Tianqi Liu, Waltham, MA (US); James A. Belmont, Acton, MA (US)

Correspondence Address: KIRKPATRICK & LOCKHART PRESTON GATES ELLIS LLP, 535 SMITHFIELD STREET, PITTSBURGH, PA, 15222, US

(21) Appl. No.: 11/351,472

(22) Filed: Feb. 10, 2006

Related U.S. Application Data
(60) Provisional application No. 60/652,043, filed on Feb. 11, 2005.

(51) Int. Cl. C08F 8/30

(52) U.S. Cl. 524/555; 524/556

(57) ABSTRACT

The present invention provides dispersible carbon particles and a process for the preparation of dispersible carbon particles. In certain embodiments, the process of the present invention comprises polymerizing monomers from a carbon particle, wherein the carbon particle comprises one or more attached groups comprising one or more transferable atoms or groups. At least a portion of the monomers comprise at least one reactive or ionizable functional group capable of conversion into ionic functional groups. Ionic functional groups enhance the dispersity of the carbon particle in the desired medium, such as the dispersity of carbon black particles in water or aqueous solutions. The process of the present invention may further include converting at least a portion of the reactive or ionizable functional groups into ionic functional groups. The ionic groups may be quaternary ammonium groups, carboxylic acid groups, phosphonium groups, sulfonium groups, iodonium groups or salts thereof.

### TECHNICAL FIELD OF THE INVENTION

The present invention relates to the preparation of modified carbon particles. More particularly, embodiments of the modified carbon particles of the present invention include dispersible carbon particles, carbon particles comprising polymer chains, and carbon particles comprising functionalized polymer chains. The present invention also relates to methods of making such modified carbon particles.

### BACKGROUND

Carbon particles include many forms, including graphite, carbon black, vitreous carbon, activated charcoal, and activated carbon. One commercially significant carbon particle is carbon black. Carbon black is substantially elemental carbon, typically from 90 wt. % to 99 wt. % of elemental carbon. Unlike diamond and graphite, which are crystalline carbons, carbon black is a disordered carbon particle composed of fused primary particles. Carbon black is comprised of particles, aggregates, and agglomerates. Carbon black primary particles are near-spherical particles with diameters in the size range of ten to 75 nanometers. These primary particles may be fused together to form aggregates. In the aggregates, primary particles are held strongly together and, for this reason, the aggregate is considered to be the smallest dispersible unit (or working unit) of carbon black. Aggregates range in size from 50-400 nm. Further, the aggregates of carbon black primary particles may form agglomerates that are collections of carbon black aggregates. The aggregates are held together with weaker van der Waals forces. Agglomerates typically range in size from 100-1000 nm. The term carbon particle, as used herein, not only includes carbon black particles, but also includes aggregates and agglomerates of carbon black and other disordered or amorphous carbon particles.

Despite its complex structures, carbon black has many commercial uses, such as, for example, in the rubber industry as a reinforcing agent, in the plastics industry for its anti-static, conductive and UV-protective capacities, as vapor-sensing materials, and as a pigment used in coatings, plastics, packaging, ink, inkjet and toner applications. Important properties of carbon black morphology include particle size, surface area, and aggregate structure.

Certain applications require carbon black dispersed in polymers, aqueous solutions, or other solvents. Control over the interfacial properties of carbon black is of great importance and remains a challenge. Dispersibility may be defined as the capability to distribute (as fine particles) evenly throughout a medium. The dispersibility of carbon black is vital to its performance in certain manufacturing processes. Proper or uniform carbon black dispersion may enhance gloss, jetness (blackness), strength, extrusion and molding characteristics, as well as many other facets of performance.

If the dispersion is not stabilized, flocculation or settling of the carbon black may occur, resulting in potential surface imperfections and flooding or flowing of tints. Incomplete dispersion of the carbon black in an aqueous medium may also result in a reduction of jetness, gloss, and conductivity of the carbon black dispersion, as well as difficulties in printing in inkjet systems.

Three methods are generally used to form polymer modified carbon black: “grafting through”, “grafting from” and “grafting onto.” “Grafting onto” involves the reaction of reactive macromolecules with functional groups on the surface of the particles. However, the macromolecules that react with the surface cause steric hindrance, preventing additional macromolecules from reaching the reactive sites on the surface of the carbon particle. Such steric hindrances limit the grafted polymer on the surface of the carbon black. “Grafting through” was developed to overcome some of the limitations of “grafting onto;” typically, olefinic polymerizable groups, preferably alkenyl groups, are attached to the surface of the carbon black, and one or more of these attached groups are incorporated into the backbone of a copolymer by conducting an uncontrolled radical polymerization in the presence of the functional carbon black. “Grafting from” typically comprises polymerizing monomers directly from an initiation site on the surface of the carbon black. “Grafting from” a surface typically affords a higher grafting density due to the much higher diffusion rate of small molecules (i.e., monomers) as compared to polymers in “grafting onto” processes.

Polymers capable of forming radicals, such as by dissociation, may also be grafted onto carbon black. As an example, TEMPO-terminated polystyrenes with controlled molecular weights and low polydispersities may be grafted onto carbon black by thermal dissociation of a C-ON bond followed by scavenging of the polymeric radicals by carbon black. The process resulted in carbon black particles comprising well-defined polymers grafted onto the surface. However, the process is inefficient; for example, the percentage of grafting was low (<20%) due to inefficient trapping of polymeric radicals, steric hindrances, and unavoidable chain-chain coupling.

Altematively, conventional radical initiators, such as peroxyesters, diazo groups, and alcoholic hydroxyl groups, have been bonded onto carbon particles' surfaces to attach polymers by conventional radical or redox initiated polymerization methods in grafting from processes. Branched polymers were also grafted onto carbon particles by post-polymerization of vinyl monomers initiated by pendent radical initiator groups attached to polymers already grafted onto carbon black.

Thus, there is a need for a process to more efficiently attach polymers to carbon black to produce a stable and dispersible carbon particle.

### SUMMARY

The present invention relates to a process for the preparation of dispersible polymer modified carbon particles. Embodiments of the process may comprise polymerizing monomers from a carbon particle, wherein the carbon particle comprises one or more attached groups comprising one or more ransferable atoms or groups. At least a portion of the monomers may comprise reactive or ionizable functional groups. The process of the present invention may form a polymer modified carbon particle comprising the carbon particle and one or more polymer chains comprising the reactive or ionizable functional groups. The reactive or ionizable functional groups may then be converted to ionic functional groups to form a particle comprising the carbon particle and one or more polymer chains comprising ionic functional groups. The ionic functional group may be formed directly from the reactive or ionizable group or from conversion of the reactive group to an ionizable group.

The process of the present invention may include monomers wherein the reactive or ionizable functional groups are ester groups or amino groups, for example. In these embodiments, converting at least a portion of the reactive or ionizable functional groups comprises hydrolyzing at least a portion of the ester groups, dealkylating at least a portion of the ester groups, or quaternizing or protonating at least a portion of the amino groups.

A further embodiment of the process for the preparation of a dispersible carbon particles comprises polymerizing monomers from a carbon particle wherein at least a portion of the monomers comprise at least one ionic group, such as a quaternary ammonium salts, to form a polymer modified carbon particle comprising the carbon particle and one or more polymer chains comprising the ionic groups.

Unless otherwise indicated, all numbers expressing quantities of ingredients, time, temperatures, and so forth used in the present specification and claims are to be understood as being modified in all instances by the term “about.” Accordingly, unless indicated to the contrary, the numerical parameters set forth in the following specification and claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, may inherently contain certain errors necessarily resulting from the standard deviation found in their respective testing measurements.

The reader will appreciate the foregoing details and advantages of the present invention, as well as others, upon consideration of the following detailed description of embodiments of the invention. The reader also may comprehend such additional details and advantages of the present invention upon making and/or using embodiments within the present invention.

### DESCRIPTION OF EMBODIMENTS

The present invention provides a process for the preparation of dispersible carbon particles. In certain embodiments, the process of the present invention comprises polymerizing monomers from a carbon particle, wherein the carbon particle comprises one or more attached groups comprising one or more transferable atoms or groups. At least a portion of the monomers comprise at least one reactive or ionizable functional group capable of conversion into an ionic functional group. Ionic functional groups enhance the dispersity of the carbon particle in the desired medium, such as the dispersity of carbon black particles in water or aqueous solutions. The process of the present invention may further include converting at least a portion of the reactive or ionizable functional groups into ionic functional groups. The reactive or ionizable functional groups may be groups comprising amino or ester functionality, for example. In certain embodiments, the reactive or ionizable functional groups may be converted to ionic functional groups by quaternizing or protonating the amino groups, thereby forming a polymer modified carbon particle comprising one or more polymer chains comprising quaternary ammonium groups or hydrolyzing or dealkylating at least a portion of the ester groups to form carboxylic acid groups and converting at least a portion of the carboxylic acid groups to a carboxylic acid salts. Additional suitable ionic groups may include phosphonium groups, sulfonium groups, iodonium groups or salts thereof. In an embodiment of the present invention, a water-dispersible carbon black may be prepared, for example, by polymerizing 2-(dimethylamino)ethyl methacrylate (DMAEMA) from a carbon black surface using atom transfer radical polymerization (ATRP) in protic medium and subsequently quaternizing or protonating the amino groups of the polymer to achieve water-dispersible carbon black. Quaternization of an attached amino group may be performed by reaction with an alkyl halide, for example.

Embodiments of the present invention also include a process for the preparation of a dispersible carbon particle, comprising polymerizing monomers from a carbon particle, wherein the carbon particle comprises one or more attached groups comprising one or more transferable atoms or groups, and at least a portion of the monomers comprise quaternary ammonium salts, to form a polymer modified carbon particle comprising the carbon particle and one or more polymer chains comprising the quaternary ammonium salts. Embodiments of the present invention also include polymerizing monomers comprising a carboxylic acid group from a carbon particle and converting at least a portion of the carboxylic acid groups to a carboxylic acid salts.

Preferably, the polymerizing of the present invention includes a controlled polymerization process (CRP), such as ATRP. “ATRP” refers to a living radical polymerization described by Matyjaszewski in U.S. Pat. Nos. 5,763,548 and 5,807,937 and in the Journal of Americal Chemical Society, vol.117, page 5614 (1995), as well as in ACS Symposium Series 768, and Handbook of Radical Polymerization, Wiley: Hoboken 2002, Matyjaszewski, K., and Davis, T. P., editors (Handbook of Radical Polymerization), all hereby incorporated by reference. An “ATRP initiator” is a chemical molecule or functionalized particle with a transferable (pseudo)halogen that can initiate chain growth. In controlled polymerizations, fast initiation is important to obtain well-defined polymers with low polydispersities. A variety of initiators, typically alkyl halides, have been used successfully in ATRP. Many different types of halogenated compounds are potential ATRP initiators. ATRP can be conducted in bulk or in solution using solvents selected to dissolve the formed copolymer.

The processes of the present invention have been exemplified by the growth of the polymers from a surface having an ATRP initiator. However, this does not exclude the use of other functional groups which could be used to initiate different CRP processes such as nitroxide mediated polymerizations, group transfer polymerization, reversible addition-fragmentation polymerization, or other polymerization process comprising a transferable atom or group, for example.

Nitroxide mediated polymerizations are described in detail in Chapter 10 of the Handbook of Radical Polymerization. Nitroxide-mediated polymerizations have the features of other controlled radical polymerizations, for example, control over PDIs and the ability to form block and gradient copolymers. It is known in the art to graft polymers from pigment surfaces using nitroxide-mediated polymerization, for instance, U.S. Pat. No. 6,664,312.

Similar techniques may be to generate particles which are modified by polymers grown from the surface, using reversible additon-fragmentation chain transfer, or RAFT, to achieve similar ends. RAFT was first described by Chiefari et al., Macromolecules, 1998, 31, 5559. The key difference between RAFT and nitroxide-mediated polymerization is the group that transfers from the polymer end to yield the active chain end is, for instance, a thiocarbonylthio group. Many others are demonstrated in the literature, including McCormick & Lowe, Accounts of Chemical Research, 2004, 37, 312-325. While we have briefly described some of the best-studied controlled radical polymerizations, other controlled radical polymerizations follow the same pattern.

Another living, or controlled, polymerization is Group Transfer Polymerization, in which a group is transferred and there is rearrangement, and an anion is the propagating species. In the best-known examples, the group transferred is trimethylsilyl chloride. The initiating group is made from the hydrosilabon of methacrylates and could be made pendant from a pigment surface. For example, an alcohol-treated surface can be treated with methacryolyl chloride to yield the methacrylic ester. This can be hydrosilated by, for example, the method taught in U.S. Pat. No. 5,332,852. This pendant GTP initiating site can be used, in the same general manner, to the same end, as the controlled radical methods discussed above.

Living/controlled polymerizations typically, but not necessarily, comprise a relatively low stationary concentration of propagating chain ends in relation to dormant chain ends. When the chain is in the dormant state, the chain end comprises a transferable atom or group. The dormant chain end may be converted to a propagating chain end by loss of the transferable atom or group.

In ATRP, radically polymerizable monomers are polymerized in the presence of a transition metal catalyst. The transition metal catalyst participates in a redox reaction with at least one of an initiator on the surface of the carbon particle and a dormant polymer chain attached to the carbon particle. Suitable transition metal catalysts comprise a transition metal and a ligand coordinated to the transition metal. Typically, the transition metal is one of copper, iron, rhodium, nickel, cobalt, palladium, or ruthenium. In some embodiments, the transition metal catalyst comprises a copper halide, and preferably the copper halide is one of Cu(I)Br or Cu(I)CI.

In certain embodiments, the carbon particle may initially need to be functonalized with a CRP initiation site to allow a grafting from process to be performed from the carbon particle to form a modified carbon black. In certain applications for the grafting from by an ATRP, a transferable atom or group, such as an activated halogen atom, may be attached to the surface of a modified carbon particle. Therefore, embodiments of the present invention may comprise forming an initiation site on the carbon particle. For example, an embodiment of the process of the present invention may comprise reacting a modified carbon particle comprising at least one carboxylic acid group with a functional initiator comprising both a group capable of reacting with the carboxylic acid group and a transferable atom or group. Preferably, the modified carbon blacks may be prepared using the methods described in U.S. Pat. Nos. 5,554,739, 5,707,432, 5,851,280, 5,885,335, 5,895,522, 5,900,029, and 6,042,643, the descriptions of which are fully incorporated herein by reference. Other methods for preparing the modified pigments include reacting a pigment having available functional groups with a reagent comprising a radically transferable atom or group. Such functional pigments may be prepared using the methods described in the references incorporated above, as well as the methods described in U.S. Pat. Nos. 6,831,194 and 6,660,075, U.S. Patent Publication Nos. 2003-0101901 and 2001-0036994, Canadian Patent No. 2,351,162, European Patent No. 1 394 221, and PCT Publication No. WO 04/63289, each of which is also incorporated in their entirety by reference herein.

The carbon particle of the present invention may be, for example, graphite, carbon black, vitreous carbon, activated charcoal, or activated carbon, but does not include ordered carbon compounds, such as single walled carbon nanotubes and multiwalled carbon nanotubes. In certain applications, the preferred carbon particle is a carbon black. Dispersions of carbon black with attached polymers provide more stable dispersions in certain applications. Representative examples of carbon particles may include various carbon black pigments (Pigment Black 7), such as channel blacks, furnace blacks and lamp blacks, and include, for example, carbon blacks sold under the Regal®, Black Pearls®, Elftex®, Monarch®, Mogul®, and Vulcan® trademarks available from Cabot Corporation (such as Black Pearls® 2000, Black Pearls® 1400, Black Pearls® 1300, Black Pearls® 1100, Black Pearls® 1000, Black Pearls® 900, Black Pearls® 880, Black Pearls® 800, Black Pearls® 700, Black Pearls® L, Elftex® 8, Monarch® 1400, Monarch® 1300, Monarch® 1100, Monarch® 1000, Monarch® 900, Monarch® 880, Monarch® 800, Monarch® 700, Mogul® L, Regal® 330, Regal® 400, and Vulcan® P, for example). The pigments may have a wide range of BET surface areas, as measured by nitrogen adsorption, depending on the desired properties of the carbon black pigments. For example, surface of the carbon black may be from about 10 m²/g to about 2000 m²/g, including from about 10 m²/g to about 1000 m²/g and from about 50 m²/g to about 500 m²/g. As is known to those skilled in the art, a higher surface area corresponds to smaller particle size. If a higher surface area is preferred and is not readily available for the desired application, it is also well recognized by those skilled in the art that the pigment may be subjected to conventional size reduction or comminution techniques, such as ball or jet milling, to reduce the pigment to a smaller particle size, if desired. In addition, when the pigment is a particulate material comprising aggregates of primary particles, such as carbon black, the pigment may have a structure which ranges from about 10 cc/100 g to about 1000 cc/100 g, including from about 40 cc/100 g to about 200 cc/100 g.

The present invention also includes carbon particles comprising attached polymer chains wherein the polymer chains generally have a polydispersity index (“PDI”) of less than 2.0. The PDI of the attached polymer chains may be controlled to less than 1.5, and even less than 1.3. If a broader PDI is desired, this can be attained by reducing the concentration of the deactivator or slowing down the rate of initiation. The PDI of the attached polymer chains may be measured by detaching the polymer chains from the carbon particle and measuring the PDI of the resulting free polymers. In certain embodiments, the modified carbon particles comprise attached polymer chains, wherein the polymer chains comprise at least one group comprising ionic functionality, such as, for example, carboxylic acid groups, salts thereof, or quaternized or protonated amino groups.

Polymer modified pigments have also been described in, for example, U.S. Pat. Nos. 6,551,393, 6,368,239, and 6,103,380, all of which are hereby incorporated by reference in their entirety.

Embodiments of the method of the present invention may be performed in bulk or in a solvent. If a solvent is used, the solvent may be a protic media or a non-protic media. A protic media is a media that comprises at least one component that is capable of being a proton donor. Preferably, the protic media of the embodiments of the present invention comprises at least 5% of the component that is capable of being the proton donor, based upon the weight of the protic media. The protic media may comprise water and at least one alcohol, for example. The alcohol of the protic media may be, for example, methanol, ethanol, propanol, isopropanol, butanol, isobutanol, heptanol, or mixtures thereof. In certain applications, it may be desired for the alcohol to comprise greater than 75 weight percent of the protic media; in other applications it may be preferable for the alcohol to comprise greater than 85 weight percent of the protic media, or between 85 weight percent and 95 weight percent of the protic media or even 85 weight percent and 90 weight percent of the protic media. Embodiments of the present invention also include polymerizing the radically polymerizable monomers in a non-protic media, wherein the protic media comprises an aromatic solvent, such as, but not limited to, anisole, xylene, benzene, a halogenated benzene derivative, or other nonprotic solvent.

Suitable monomers used in the polymerization step of the present invention comprise at least one diene group or at least one vinyl group. Examples include, but are not limited to, acrylate esters, (meth)acrylate esters, acrylonitriles, cyanoacrylate esters, maleate and fumarate diesters, vinyl pyridines, vinyl N-alkylpyrroles, vinyl oxazoles, vinyl thiazoles, vinyl pyrimidines, vinyl imidazoles, vinyl ketones, acrylic acids, (meth)acrylic acids, styrenes, and derivatives of these monomers. Vinyl ketones include those in which the α-carbon atom of the alkyl group does not bear a hydrogen atom, such as vinyl ketones in which both α-carbons bear a C₁-C₄ alkyl group, halogen, etc. or a vinyl phenyl ketone in which the phenyl group may be substituted with from 1 to 5 C₁-C₆ -alkyl groups and/or halogen atoms. Styrenes include those in which the vinyl group is substituted with a C₁-C₆ alkyl group, such as at the α-carbon atom, and/or those in which the phenyl group is substituted with from 1 to 5 substituents including a C₁-C₆ alkyl, alkenyl (including vinyl), alkynyl (including acetylenyl), or phenyl group, and functional groups such as C₁-C₆ alkoxy, halogen, nitro, carboxy, C₁-C₆ alkoxycarbonyl, hydroxy (including those protected with a C₁-C₆ acyl group), and cyano groups. Specific examples include methyl acrylate (MA), methyl methacrylate (MMA), butyl acrylate (BA), 2-ethylhexyl acrylate (EHA), acrylonitrile (AN), methacrylonitrile, styrene, and derivatives thereof. Monomers comprising nitrogen-containing ionizable groups may be DMAEMA, acrylamide, acrylonitrile, methacrylonitrile, vinyl pyridine, and derivatives of these monomers, for example. Monomers comprising ester functionality include esters of acrylic acid, such as acrylate esters of C₁-C₂₀ alcohols, (meth)acrylate esters of C₁-C₂₀ alcohols, methyl acrylate, methyl (meth)acrylate, t-butyl acrylate, t-butyl (meth)acrylate, 2-ethylhexyl acrylate, and derivatives of these monomers. The process of the present invention also includes a process wherein at least a portion of the monomers includes amino groups or ester groups that may be converted to ionic functionality.

The polymer chains comprising ionic functional groups such as quaternary ammonium groups and carboxylic acid groups or salts thereof may be of the formula: 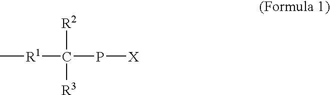
wherein the R¹ is R⁴R⁵, where R⁴ and R⁵ are independently selected from one of a bond, an unsubstituted or substitued arylene group, an unsubstituted or substitued alkylene group, unsubstituted or substitued aralkylene, unsubstituted or substitued alkarylene, —O—, —S—, —OR⁶—, —NR⁶—, —S(═O)—, —C(═O)—, —COO—, SOO—, —NR⁶C—, —CNR⁶—, and —C —P(O)₂O—, or —P(OR⁶)OO—; R⁶ is one of H, an alkyl, alkylene, an aryl or arylene; R² and R³ are independently selected from H, an alkyl group, an aryl group, —OR⁷, —NHR⁷, —N(R⁷)₂, or —SR⁷; wherein R⁷ is independently selected from one of an alkyl group or an aryl group; X is a 5 transferable atom or group and P represents a polymer chain comprising at least one ionic functional group such as a quaternary ammonium group or a carboxylic acid group or salt thereof, wherein R¹ is not a peroxide;

wherein P is a polymer comprising radically polymerizable monomers and is one of a homopolymer, a random copolymer, a block copolymer, a graft polymer, a branched polymer, gradient copolymer or an alternating copolymer.

The monomers comprising quaternary ammonium groups may, for example, have one of the following formulae:

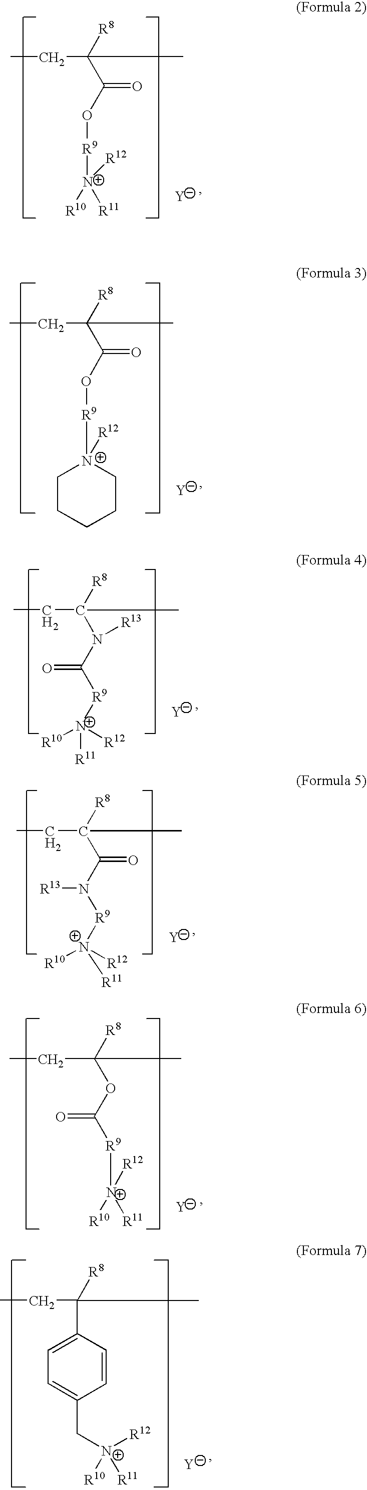

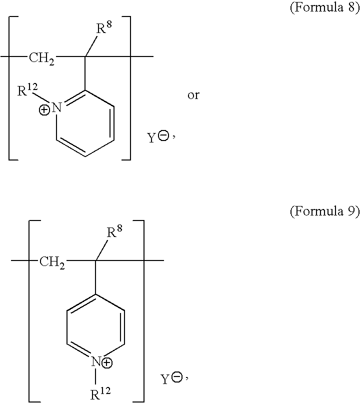

wherein R⁸ is H, CH₃, CI or CN, R⁹ is branched or unbranched C₁-C₆ alkylene, R¹⁰ and R¹¹ are, independently, branched or unbranched C₁-C₅ alkyl or isopropyl, and R¹² and R¹³ are independently selected from H, branched or unbranched C₁-C₆ alkyl or benzyl, and Y is a counterion.

The following examples demonstrate embodiments of the process and composition of the present invention.

### EXAMPLES

Materials

Monomers, n-butyl acrylate (n-BA), t-butyl acrylate (t-BA), 2-(dimethylamino)ethyl methacrylate (DMAEMA), 2-hydroxyethyl methacrylate (HEMA), and [2-(methacryloyloxy)ethyl]trimethylammonium chloride (DMAEMA-Cl, 75 wt % solution in water) were purchased from Aldrich and passed through a basic alumina column prior to polymerization. Transition metal salt, CuBr (97%), was obtained from Aldrich and purified by stirring over glacial acetic acid (Fisher Scientific), followed by filtration and washing of the solid three times with ethanol and twice with diethyl ether, and vacuum dried overnight CuBr₂, 2,2′-bipyridine, pyridine, 4-dimethylaminopyridine (4-DMAP) and 1,3-dicyclohexylcarbodiimide (DCC), methyl 2-bromopropionate (MBP) and N,N,N′,N′,N″-pentamethyldiethylenetriamine (PMDETA) were obtained from Aldrich and were used as received. 2,2-Dimethyl-3-hydroxypropyl α-bromoisobutyrate was synthesized according to Newman, M. S., Kilboum E. J., Org. Chem. 1970, 35, 3168-3188. Anisole was obtained from Aldrich and dried over Å molecular sieves. Carbon black (Monarch 700) is available from the Cabot Corporation.

For water insoluble polymers, molecular weights and PDIs were measured using a Waters 712 WISP autosampler and PSS guard and 10⁵, 1000 and 100 Å columns in THF at a flow rate of 1 mL/min. Prior to sample injection, the polymer samples were dissolved in THF with toluene as the internal standard and passed through a short column with neutral alumina and a 0.2 μ PFTE filter to remove copper and dust. If the sample contained carbon black, multiple filtrations through 0.45 μ filters followed by 0.2 μfilters were conducted.

For water soluble polymers, the molecular weight and polydispersites of the samples were determined based on a calibration curve generated from poly(styrene) standards in conjunction with a Waters 410 differential refractometer. Additionally, molecular weights of the kinetic samples were measured by GPC (Waters 717) by dissolving the polymer samples in DMF with a drop of toluene as the internal standard and using DMF as the eluent at a flow rate of 1 mL/min. In the case of poly(DMAEMA), the molecular weight and polydispersities of the samples were determined based on a calibration curve generated from poly(methyl methacrylate) standards in conjunction with a refractive index detector.

Centrifugation of the samples was performed in a refrigerated Sorvall® RC 5C plus centrifuge at 16,500 rpm (corresponding to 39,000 gforce) at 4° C.

The determination of the amount of grafted polymer on carbon black was performed on an AutoTGA 2950 (TA Instruments).

About 10 mg of the dried samples was placed in a Pt pan under nitrogen. The samples were kept at 110° C. for 10 minutes before heating to 650° C. at 10° C./min. Finally, the samples were maintained at 650° C. for 15 minutes.

The size of the polymer grafted carbon black was measured on a MICROTRAC Particle Size Analyzer (UPA), L&N 179521. The measurement technique is dynamic light scattering. The dispersions of carbon black particles are diluted in a suitable solvent until the final concentrations are as low as a few parts per million (ppm). The sample cell is a 316 stainless-steel cell with a capacity for samples 3-8 ml in volume, and the acquisition time for the sample measurement is 360 seconds.

### Example 1

### Carboxylating Carbon Black

Carbon black BP700 powder (500 g, Cabot Corporation) and p-aminobenzoic acid (137.14 g, Aldrich) in 920 g distilled water were combined in a ProcessAll Mixer. This mixture was heated at 50-55 ° C. and mixed at 300 rpm for 10 minutes. Sodium nitrite, (69 g, Aldrich) was dissolved in 207 mL of water and this solution was pumped into the reactor over 10-15 minutes. The resultant mixture was heated at 60° C. for 2 hours. The contents were removed by dilution with water to a final concentration of about 15% (by weight) solids and then purified by centrifugation and diafiltrabon with 7.5 volumes of water.

### Example 2a

### CB Initiator Synthesis (CB-Br).

15 g of the aqueous dispersion produced in Example 1 was acidified to pH 2 to precipitate the carbon black. After the carbon black was washed with DI water and isolated by centrifugation several times, it was dried under vacuum at 60° C. for 12 hours prior to the esterification. The carbon black was homogenized in 250 mL of dry THF. To this dispersion, 16 g of DCC, 2.5 g of DMAP and 19.4 g of 2,2-dimethyl-3-hydroxypropyl α-bromoisobutyrate were added. The reaction was homogenized for five hours and allowed to proceed overnight while stirred by a magnetic stirbar. The functionalized carbon black was then purified by multiple centrifugations in THF or methanol.

### Example 2b

### CB Initiator Synthesis (CB-Br)

5 g of the aqueous dispersion produced in Example 1 was acidified to pH 2 to precipitate the carbon black. After the carbon black was washed with DI water and isolated by centrifugation several times, it was dried under vacuum at 60° C. for 12 hours prior to the esterification. The surface carboxylic acid groups were reacted with 20 mL of SO₂CI in 20 mL of dry THF under homogenized condition. After excess SO₂CI and solvent were removed under vacuum, 3.3 g of 2,2-dimethyl-3-hydroxypropyl α-bromoisobutyrate and 4.60 g of butoxy ethanol in 40 mL of THF was added into the system. The reaction was homogenized for five hours before the homogenizer was switched to magnetic stir bar and the reaction was allowed to continue overnight. The functionalized carbon black was then purified by multiple centrifugations in THF or methanol.

### Example 3a

### ATRP Polymerization of n-BA from Carbon Black

One of the advantages of controlled radical polymerizations over conventional radical polymerizations is that block copolymers can be easily synthesized by chain extension with the second block. The block copolymerization was conducted to test whether the chain ends of the first block were available for chain extension.

The material of Example 2a (CB-Br 1.20 g, 0.238 mmol, 0.198 mmol Br/g carbon black), CuBr₂ (0.5 mL stock solution, 0.0143 mmol), PMDETA (100 μ, 0.476 mmol), n-BA (11.3 g, 0.088 mol) and anisole (8 mL) were added into a Schlenk flask and degassed. CuBr (0.068 g, 0.476 mmol) was then added while the contents were frozen and protected under nitrogen. The reaction was allowed to proceed for 12.5 hours at 70° C. and a conversion of 7 wt % of n-BA was obtained by GC. The CB-poly(n-BA) was isolated and purified by centrifugation before being used as the macroinitiator for the block copolymerization of t-BA. These particles formed dispersions in THF with a particle size of 182 nm, and had a volatiles content by TGA of 25%.

### Example 3b

### Preparation of CB- Poly(n-BA-b-t-BA)

The poly(n-BA)-grafted carbon black of Example 3(a) was then used to initiate the polymerization of t-BA. Poly(n-BA) (0.76 g) was dried under vacuum before anisole (4 mL) was added. The mixture was sonicated in an ice/water ultrasonic bath for half an hour before t-BA (5.65 g, 0.044 mmol) and CuBr₂ solution (0.25 mL stock solution, 0.00714 mmol) were added and sonicated for another five minutes under nitrogen. After the addition of PMDETA (50 μL, 0.238 mmol), the dispersion was subject to the usual freeze-pump-thaw cycles before CuBr (0.034 g, 0.238 mmol) was added under nitrogen. The reaction was allowed to run for 60 hours, and the materials were purified as in Example 3a. These particles also dispersed in THF and have a particle size of 302, and a volatiles content of 76%.

### Example 4

### Detaching Polymers from the Surface and Analysis

After purification, the polymers grown on the carbon black surface in Examples 3a and 3b were detached and measured by GPC in THF. The molecular weight of polymers detached from 3a is 1950; the polymer detached from 3b has a molecular weight of 33,900. There is a clear shift of molecular weight compared to the first poly(n-BA) block detached from carbon black, indicating that the polymer chains from Example 3a served as initiators for the polymer grown in Example 3b.

### Example 5

### Formation of Dispersible Carbon Black by Hydrolyzation of Hydrolyzable Ester Groups

The block copolymer-grafted carbon black prepared in Example 3b (0.5 g) was hydrolyzed by placing it in a solution of 1.14 g trifluoroacetic acid dissolved in 20 mL THF overnight. The resulting polymer-grafted carbon black was dispersible in water under basic conditions. The aqueous dispersion had a particle size of 325 nm, and the dried material was 65% by weight volatiles.

### Example 6

### Polymerization of DMAEMA from Functionalized Carbon Black Surface (CB-PDMAEMA)

The material of Example 2b (functionalized carbon black CB-Br, 0.58 g, 0.15 mmol) was added into a Schlenk flask and dried under a vacuum at r.t. for one hour. DMAEMA (11.8 g, 75 mmol), MeOH (11 g), water (1.4 g), DMF (1.0 mL), bipyridine (0.15 g, 0.96 mmol) and CuBr₂ (0.040 g, 0.18 mmol) were then added to the Schlenk flask. The flask was then degassed by four freeze-pump-thaw cycles. While the contents were frozen in liquid nitrogen, the flask was backfilled with nitrogen and CuBr (0.043 g, 0.3 mmol) was added. The flask was then degassed and backfilled with nitrogen twice, then allowed to warm up to room temperature, and an initial sample (t=0) was collected by syringe. The flask was then placed in an oil bath thermostatted at 30° C. Samples were taken out of the flask periodically. Conversion of the monomer was monitored by both NMR and GC, and the polymerization stopped at 18 hours. The carbon black particles were isolated by centrifugation and sonification in methanol. The sample was then centrifuged at 39,000 g for two hours. The process was repeated till there was no free polymer detectable in the supematant by GPC. The material was 58% volatile by weight and displayed a particle size of 342 nm in MeOH. Despite the incorporation of MMA in the polymerization due to the transesterification of DMAEMA in methano/H₂O, the polymer-grafted carbon black forms stable water dispersions under acidic conditions or upon quaternization using alkyl bromide.

### Example 7

### Dispersion of Example 6 in Acidic Water. 120 nm, 57%

A small amount of the material of Example 6 was dispersed in water at pH 2 by sonication. The particle size was 462.

### Example 8

### Quaternization of CB-PDMAEMA by Ethyl Bromide

The material of Example 7 (CB-PDMAEMA, 0.5 g), dispersed in 20 mL THF by sonication, was treated with 10 mL of ethylbromide, and the mixture was allowed to stir overnight. The particles precipitated overnight. The precipitated particle was isolated by evaporating the solvent and excess alkyl halide. The material was 74% by weight volatile and was dispersible in water with a particle size of 683 nm.

The degree of quaternization was calculated from the NMR integration of the quaternized and unquaternized amino-methyl groups, and was 67%. The sample was 74% volatiles by TGA and had a particle size of 462 nm.

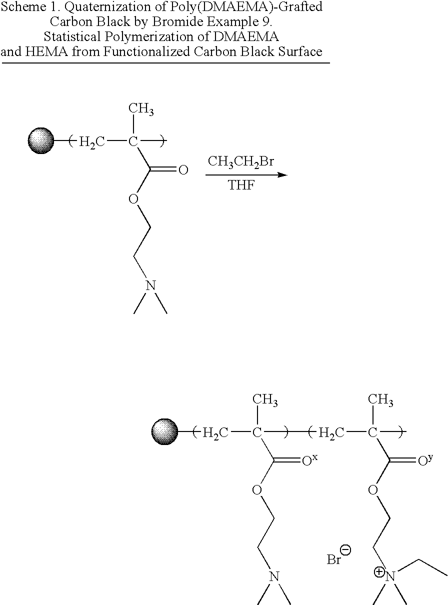

The material of Example 2a (CB-Br, 0.87 g, 0.15 mmol) was added into a Schlenk flask and dried under vacuum at r.t. for one hour. To the Schlenk flask were added DMAEMA (9.83 g, 62.5 mmol), HEMA (1.63 g, 12.5 mmol), MeOH (11 g), water (1.4 g), bipyridine (0.15 g, 0.96 mmol) and CuBr₂(0.040 g, 0.17 mmol). The flask was then degassed by four freeze-pump-thaw cycles. While the contents were frozen in liquid nitrogen, the flask was backfilled with nitrogen and CuBr (0.043 g, 0.3 mmol) was added. The flask was then degassed and backfilled with nitrogen twice, then allowed to warm up to room temperature and an initial sample (t=0) was collected by syringe. The flask was then placed in an oil bath thermostatted at 30-32° C. Aliquots were taken out of the flask periodically. Conversion of the monomer was monitored by both NMR and GC. The reaction was stopped at 18 hr.

### Example 10

### Polymerization of HEMA from CB-PDMAEMA

The material of Example 6, CB-PDMAEMA (0.35 g), was added into a Schlenk flask and dried under vacuum at room temperature for one hour. To the Schlenk flask were added HEMA (6.52 g, 50 mmol), MeOH (8 g), water (1.0 g), bipyridine (0.075 g, 0.48 mmol), CuBr (0.0215 g, 0.15 mmol) and CuBr₂ (0.020 g, 0.085 mmol). The flask was then degassed as described before. The same polymerization conditions as in Example 9 were used, and after 18 hours of reaction, a monomer conversion around 5.7% was detected by GC. As the reaction proceeded, the polymer-grafted carbon black was found to precipitate out from the solution. After removing the solvent, the particles were readily dispersible in water after sonification. The dispersions were stable throughout the pH range and even in boiling water. The formation of block copolymers was confirmed by a solubility test: the materials of Example 6, CB-PDMAEMA, dispersed in acetone, but the material of Example 10 did not disperse in acetone, but did disperse in methanol. This is consistent with the known solubilities of the homopolymers of DMAEMA and HEMA. The presence of PHEMA was also confirmed by IR, and TGA indicated the volatile content increased from 51% to 68% and a light scattering showed the particle size increased from 198 nm to 283 nm.

### Example 11

### Polymerization of DMAEMA-CI from CB-Br

The material of Example 2a, CB-Br (0.58 g), was mixed with 5.54 g DMAEMA-CI aqueous solution. 0.019 g of CuBr₂, 0.77 g pyridine, 0.15 g bipyridine, 2 g of water, 0.5 mL of DMF and 2 g of methanol in a Schlenk flask. The flask was then degassed by four freeze-pump-thaw cycles. While the contents were frozen in liquid nitrogen, the flask was backfilled with nitrogen and CuBr (0.057 g) was added. The flask was then degassed and backfilled with nitrogen twice, then allowed to warm up to room temperature. The polymerization was performed at 30-32° C. for 16 hrs. After purification, the polymer bound carbon black was dispersible in water and showed a particle size of 570 nm measured in DI water. The volatile content was found to be 74%.

1. A process for the preparation of a dispersible carbon particle, comprising:
polymerizing monomers from a carbon particle, wherein the carbon particle comprises one or more attached groups comprising one or more transferable atoms or groups, and wherein at least a portion of the monomers comprise reactive or ionizable functional groups, to form a polymer modified carbon particle comprising the carbon particle and one or more polymer chains comprising the reactive or ionizable functional groups; and
converting at least a portion of the reactive or ionizable functional groups to ionic functional groups, to form a polymer modified carbon particle comprising the carbon particle and one or more polymer chains comprising ionic functional groups.

2. The process of claim 1, wherein the reactive or ionizable functional groups are amino groups and converting at least a portion of the reactive or ionizable functional groups comprises quaternizing at least a portion of the amino groups to form a polymer modified carbon particle comprising the carbon particle and one or more polymer chains comprising quaternary ammonium groups.

3. The process of claim 2, wherein the polymerizing is conducted in a protic media.

4. The process of claim 3, wherein the protic media comprises water and at least one alcohol.

5. The process of claim 4, wherein the alcohol is methanol, ethanol, propanol, isopropanol, butanol, isobutanol, or heptanol.

6. The process of claim 5, wherein the alcohol comprises greater than 75 weight percent of the protic media.

7. The process of claim 6, wherein the alcohol comprises greater than 85 weight percent of the protic media.

8. The process of claim 7, wherein the alcohol comprises between 85 weight percent and 95 weight percent of the protic media.

9. The process of claim 8, wherein the alcohol comprises between 85 weight percent and 90 weight percent of the protic media.

10. The process of claim 1, wherein the monomers comprise at least one diene group or at least one vinyl group.

11. The process of claim 2, wherein the monomers comprising reactive or ionizable functional groups are selected from monomers comprising at least one diene group or at least one vinyl group, acrylate esters, (meth)acrylate esters, acrylonitriles, cyanoacrylate esters, maleate and fumarate diesters, vinyl pyridines, vinyl N-alkylpyrroles, vinyl oxazoles, vinyl thiazoles, vinyl pyrimidines, vinyl imidazoles, vinyl ketones, acrylic acids, (meth)acrylic acids, styrenes, methyl acrylate (MA), methyl methacrylate (MMA), butyl acrylate (BA), 2-ethylhexyl acrylate (EHA), acrylonitrile (AN), methacrylonitrile, styrene, DMAEMA, acrylamide, acrylonitrile, methacrylonitrile, vinyl pyridine, acrylate esters of C₁-C20 alcohols, (meth)acrylate esters of C₁-C20 alcohols, methyl acrylate, methyl (meth)acrylate, t-butyl acrylate, t-butyl (meth)acrylate, 2-ethylhexyl acrylate, and derivatives of these monomers.

12. The process of claim 2, wherein the polymer chains comprising quaternary ammonium groups have the formula: 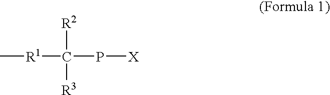
wherein the R¹ is R⁴R⁵, where R⁴ and R⁵ are independently selected from one of a bond, an unsubstituted or substitued arylene group, an unsubstituted or substitued alkylene group, unsubstituted or substitued aralkylene, unsubstituted or substitued alkarylene, —, —S—, —OR⁶—, —NR⁶—, —S(═O)—, —C(═O)—, —COO—, SOO—, —NR⁶C-, —CNR⁶—, and —C —P(O)₂O—, or —P(OR⁶)OO—; R⁶ is one of H, an alkyl, alkylene, an aryl or arylene; R² and R³ are independently selected from H, an alkyl group, an aryl group, —OR⁷, —NHR⁷, —N(R⁷)₂, or —SR⁷; wherein R⁷ is independently selected from one of an alkyl group or an aryl group; X is a transferable atom or group and P represents a polymer chain comprising at least one ionic functional group wherein R¹ is not a peroxide; and P is a polymer comprising radically polymerizable monomers.

13. The process of claim 2, wherein the ionic functional group is at least one of a quaternary ammonium group or a carboxylic acid group.

14. The process of claim 13, wherein at least one monomer of the polymer chain comprises quaternary ammonium groups and the at least one monomer of the polymer chain has one of the following formulae: 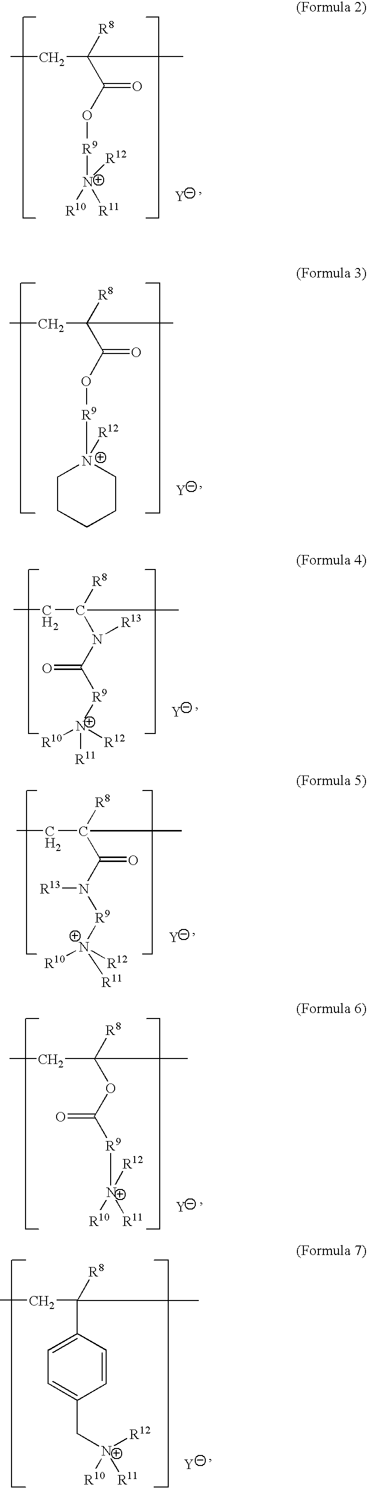 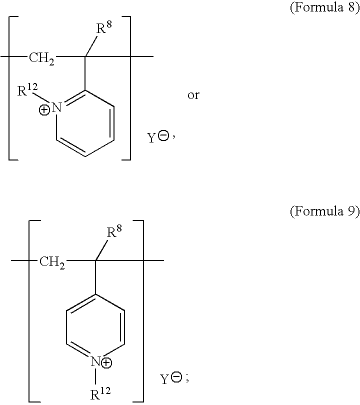
wherein, R⁸ is H, CH₃, CI or CN, R⁹ is branched or unbranched C₁-C6 alkylene, R¹⁰ and R¹¹ are, independently, branched or unbranched C₁-C5 alkyl or isopropyl, R¹² and R¹³ are, independently, one of H, branched or unbranched C₁-C16 alkyl or benzyl, and Y is a counterion.

15. The process of claim 12, wherein P is one of a homopolymer, a random copolymer, a block copolymer, a graft copolyrner, a branched copolymer, gradient copolymer or an alternating copolymer.

16. The process of claim 1, wherein the polymerizing is an atom transfer radical polymerization, a nitroxide mediated polymerization, reversible addition-fragmentation chain transfer, or a group transfer polymerization.

17. The process of claim 16, wherein the polymerizing is in the presence of a transition metal catalyst, and wherein the transition metal catalyst participates in a redox reaction with the at least one of the particles.

18. The process of claim 17, wherein the transition metal catalyst comprises a transition metal and a ligand coordinated to the transition metal.

19. The process of claim 18, wherein the transition metal is one of copper, iron, rhodium, nickel, cobalt, palladium, or ruthenium.

20. The process of claim 18, wherein the transition metal catalyst comprises a copper halide.

21. The process of claim 20, wherein the copper halide is one of Cu(I)Br or Cu(I)CI.

22. The process of claim 16, wherein the monomers are radically polymerizable monomers, and the transferable atom or group is a radically transferable atom or group.

23. The process of claim 16, wherein the monomers are anionically or cationically polymerizable monomers.

24. The process of claim 1, wherein the carbon particle is graphite, carbon black, vitreous carbon, activated charcoal, and activated carbon.

25. The process of claim 1, wherein the carbon particle is carbon black.

26. The process of claim 25, wherein the carbon particle comprises greater than 90 weight percent of elemental carbon.

27. The process of claim 26, wherein the carbon particle comprises greater than 95 weight percent of elemental carbon.

28. The process of claim 2, wherein at least a portion of the monomers do not comprise amino groups.

29. The process of claim 1, wherein the reactive or ionizable functional groups are ester groups and converting at least a portion of the reactive or ionizable functional groups comprises one of hydrolyzing or dealkylating at least a portion of the ester groups to form a polymer modified carbon particle comprising the carbon particle and one or more polymer chains comprising carboxylic acid group and converting at least a portion of the carboxylic acid groups to a carboxylic acid salts.

30. The process of claim 29, wherein the polymerizing is in a non-protic media.

31. The process of claim 30, wherein the non-protic media comprises an aromatic solvent.

32. The process of claim 31, wherein the aromatic solvent is anisole, xylene, benzene, or a halogenated benzene derivative.

33. The process of claim 1, wherein the polymerizing is done in bulk.

34. The process of claim 29, wherein the ester group comprises a t-butyl group.

35. The process of claim 29, wherein the monomers comprising ester groups are selected from t-butyl acrylate, t-butyl methacrylate, and derivatives of these monomers.

36. The process of claim 29, wherein the polymer chains are a homopolymer, a copolymer, a random copolymer, a block copolymer, a graft copolymer, a branched copolymer, or an alternating copolymer.

37. The process of claim 29, wherein the carbon particle is graphite, carbon black, vitreous carbon, activated charcoal, or activated carbon.

38. The process of claim 29, wherein the carbon particle is carbon black.

39. The process of claim 29, wherein at least a portion of the radically polymerizable monomers do not comprise ester groups.

40. The process of claim 1, further comprising: reacting a modified carbon particle comprising at least one carboxylic acid group with a functional initiator comprising a radically transferable atom or group to form the carbon particle having attached one or more groups comprising one or more radically transferable atoms or groups.

41. A process for the preparation of a dispersible carbon particle, comprising:
polymerizing monomers from a carbon particle, wherein the carbon particle comprises one or more attached groups comprising one or more transferable atoms or groups, and wherein at least a portion of the monomers comprising at least one of a quaternary ammonium salts or a carboxylic acid group, or a salt thereof, to form a polymer modified carbon particle comprising the carbon particle and one or more polymer chains comprising the quaternary ammonium salts.

42. The process of claim 41, wherein the polymerizing is conducted in a protic media.

43. The process of claim 42, wherein the protic media comprises water and at least one alcohol.

44. The process of claim 43, wherein the alcohol is methanol, ethanol, propanol, isopropanol, butanol, isobutanol, or heptanol.

45. The process of claim 44, wherein the alcohol comprises greater than 75 weight percent of the protic media.

46. The process of claim 45, wherein the alcohol comprises greater than 85 weight percent of the protic media.

47. The process of claim 46, wherein the alcohol comprises between 85 weight percent and 95 weight percent of the protic media.

48. The process of claim 47, wherein the alcohol comprises between 85 weight percent and 90 weight percent of the protic media.

49. The process of claim 41, wherein the monomers comprise at least one diene group or at least one vinyl group.

50. The process of claim 41, wherein the polymerizing is an atom transfer radical polymerization, a nitroxide mediated polymerization, reversible addition-fragmentation chain transfer, or a group transfer polymerization.

51. A dispersible carbon particle, comprising:
a carbon particle;
a plurality of polymer chains attached to the carbon particle, wherein at least a portion of the polymer chains comprise ionic functionality and a PDI of less than 2.0.

52. The dispersible carbon particle of claim 51, wherein the polymer chains comprise at least one of radically polymerizable monomers or ionically polymerizable monomers.

53. The dispersible carbon particle of claim 51, wherein the PDI is less than 1.5.

54. The dispersible carbon particle of claim 53, wherein the PDI is less than 1.3.

55. The dispersible carbon particle of claim 54, wherein the ionic functionality comprises at least one of carboxylic acid groups, salts thereof, or quaternized or protonated amino groups.

56. The process of claim 1, further comprising forming an aqueous dispersion of the polymer modified carbon particle.
